(19) United States
(12) Patent Application Publication
(10) Pub. No.: US 2014/0010433 A1
(43) Pub. Date: Jan. 9, 2014

(54) SYSTEM AND METHOD FOR IMPROVED DETECTION OF OBJECTS OF INTEREST IN IMAGE DATA BY MANAGEMENT OF FALSE POSITIVES

(71) Applicants: Ajay Divekar, Herndon, VA (US); Corina Villavicencio, Ashburn, VA (US); Yuan-Ming Lure, Potomac, MD (US)

(72) Inventors: Ajay Divekar, Herndon, VA (US); Corina Villavicencio, Ashburn, VA (US); Yuan-Ming Lure, Potomac, MD (US)

(21) Appl. No.: 13/883,425

(22) PCT Filed: Nov. 3, 2011
(86) PCT No.: PCT/US11/59194

§ 371 Date: Sep. 20, 2013

Related U.S. Application Data
(60) Provisional application No. 61/409,776, filed on Nov. 3, 2010.

(51) Int. Cl. G06K 9/00

(52) U.S. Cl. CPC G06K 9/00127
USPC 382/133

(57) ABSTRACT

A system and method for improved detection of objects of interest in image data using adaptive stepwise classification and hierarchical decision diagrams to manage false positives is provided. The present invention uses an adaptive stepwise classification approach, preferably based on a hierarchical binary decision diagram (BDD), to enable the efficient management of false positive objects to improve detection performance. The present invention is particularly suited for the reduction of false positives during the detection of acid fast bacilli associated with tuberculosis.

### REFERENCE TO RELATED APPLICATIONS

This application claims priority to U.S. Provisional Patent Application No. 61/409,776, filed Nov. 3, 2010, which is incorporated herein by reference in its entirety.

### BACKGROUND OF THE INVENTION

1. Field of the Invention

This invention relates to image analysis and, more specifically, to a system and method for improved detection of objects of interest in image data using adaptive stepwise classification and hierarchical decision diagrams to manage false positives.

2. Background of the Related Art

Tuberculosis (TB) is the main cause of deaths due to infectious disease. According to the World Health Organization (WHO), one-third of the world's population are carriers of these TB bacteria, originating about 10 million cases of active tuberculosis worldwide and approximately 3 million deaths annually. TB infection is currently spreading at the rate of one person per second. Bacteria of the mycobacterium family produce a positive stain with special dyes and are referred to as acid-fast bacteria (AFB). The presence of AFB on a sputum smear or other specimen often indicates the TB disease.

Routine visual slide screening for identification and count of AFB involves manual screening for the AFB identification which is a tedious labor-intensive task. Poor, inconsistent slide staining technique, debris, variation in human perception, tedium and fatigue lead to low sensitivity which may cause diagnostic errors of up to 50%, especially in scanty specimens. In many instances, only a few bacilli are scattered over the entire slide, making detection extremely difficult to find and isolate by human observation. Also, the bacilli may be faint (poorly stained), occluded, obscured by cells or remnants, sputum debris or inside macrophages—this imparts a hazy outline to the bacilli which may cause oversights in recognition. In addition, the background can be complex due to debris and other features in the sputum, making visualization and accurate recognition more difficult.

Although in clinical practice, the case detection sensitivity is low as reported by WHO, many controlled studies have shown that the sensitivity of smear sputum for the identification of TB can reach 90%, with up to a 5% false positive rate, by changing the concentration of sputum samples, meticulously searching hundreds of fields of view via microscopy, and using improved staining techniques to remove the complicated background. In other words, the missed TB bacilli could have been detected if a more systematic and meticulous method had been utilized.

Computer aided detection (CAD) provides a systematic, consistent, and automatic detection methodology using advanced image processing, image analysis, artificial intelligence, statistical signal detection theory, and precision and robust training with large amounts of cases. Such technical approaches have been successfully demonstrated and well documented in early detection of breast and lung cancer on x-ray images, and cervical cancer on slides. Applying a computer-aided-detection system to the automated diagnosis of TB provides the opportunity to address the shortcomings of current techniques in diagnosing TB from sputum smears.

Several computer-aided diagnosis or detection (CAD) techniques using digital image processing and artificial neural networks have been described in the related art for the detection of bacteria. Some of the more particularly relevant work includes: [1] K. Veropoulos, G. Learmonth, C. Campbell, B. Knight, and J. Simpson, “Automatic identification of tubercle bacilli in sputum. A preliminary investigation,” Analytical and quantitative cytology and histology 21(4), p. 277, 1999; [2] K. Veropoulos, C. Campbell, G. Learmonth, B. Knight, and J. Simpson, “The automatic identification of tubercle bacilli using image processing and neural computing techniques,” in Proceeding of the 8th international conference on artificial neural networks, 2, p. 797, 1998; [3] Manuel G. Forero, Filip Sroubek, Gabriel Cristóbal, “Identification of tuberculosis bacteria based on shape and color, Real-Time Imaging,” v. 10 n. 4, p. 251-262, August 2004; [4] P. Sadaphal, J. Rao, G. Comstock, and M. Beg, “Image processing techniques for identifying Mycobacterium tuberculosis in Ziehl-Neelsen stains,” Int. J. Tuberc. Lung Dis., vol. 12, no. 5, pp. 579-582, May 2008; [5] Rethabile Khutlang, Sriram Krishnan, Ronald Dendere, Andrew Whitelaw, Konstantinos Veropoulos, Genevieve Learmonth, Tania S. Douglas, “Classification of mycobacterium tuberculosis in images of ZN-stained sputum smears”, IEEE Transactions on Information Technology in Biomedicine, Volume 14 Issue 4, July 2010; [6] TADROUS Paul J. “Computer-Assisted Screening of Ziehl-Neelsen-Stained Tissue for Mycobacteria: Algorithm Design and Preliminary Studies on 2,000 Images”, American journal of clinical pathology, 2010, vol. 133, no 6, pp. 849-858; and [7] U.S. Pat. No. 6,125,194, “Method and system for re-screening nodules in radiological images using multi-resolution processing, neural network, and image processing,” by Yeu, Lure, and Lin.

Publications [1] and [2] describe the use of shape descriptors and neural network classifiers as an identification method. Further, this work used invariant moment and Fourier coefficients as a feature set to describe the bacteria. Two different learning rules from neural network were used: (1) the back propagation of error; and (2) the scaled conjugate gradient. The methodology described in these publications considered all the false positives as one category, and also use one classification of neural network that only discriminate bacilli from non-bacilli.

The methodology described in publication [3] uses color, Fourier moment, invariant moment as features. This work used the cluster analysis to determine bacilli vs. non-bacilli based on the distance between cluster center and feature parameters. Further, this methodology considered all the false positives as one category, and also uses one classification of neural network that only discriminates bacilli from non-bacilli.

Publication [4] describes a methodology in which multi-stage, color-based Bayesian segmentation is used to identify possible TB objects. This methodology also uses two shape descriptors (axis ratio and eccentricity) to recognize rod-shape objects. Similar to other related art, the methodology described in publication [4] considered all the false positives as one category. Further, only one decision tree classifier is used for discriminating bacilli from non-bacilli.

The work described in publication [5] uses geometric transformed invariant features and feature optimization and selection to select the optimal subset of features for further classification. This work investigates different classification schemes, including Bayesian, linear, quadratic, k-nearest neighborhood, support vector machine, and probabilistic neural network. Like the other related art, this methodology considered all the false positives as one category. Additionally, only one classification of neural network is used that only discriminates bacilli from non-bacilli.

Publication [6] describes an image analysis approach that analyzes the whole image for evidence of AAFB (anywhere in the image), and a single number is calculated that characterizes that probability. This approach uses two features: (1) color assessment; and (2) local contrast assessment. Like the others, this approach considered all the false positives as one category, and uses one classification of neural network that only discriminates bacilli from non-bacilli.

Most CAD methods, such as the ones described above, separate the targets into two categories (disease and non-disease) using a single-step simultaneous classification method to differentiate disease from non-disease. Such an approach places all the false positives (FPs) into one single category, all of the disease into another category, and further attempts to classify them in a single non-linear classifier. Frequently, this approach lets the classifier determine its own hyperplane for the separation of two categories during the training process. Such training is completely based on the characteristics of training data.

Although this approach is quite useful when the characteristics between disease and non-disease are relatively unknown, it can cause overtraining when the numbers of disease and non-disease objects are unbalanced and, furthermore, the representation of training samples is uncertain. Such an approach does not preserve previously trained classifiers. Therefore, the classifier needs to be re-trained every time new training cases emerge. This simultaneous classification lacks incremental learning capabilities.

### SUMMARY OF THE INVENTION

An object of the invention is to solve at least the above problems and/or disadvantages and to provide at least the advantages described hereinafter.

Therefore, an object of the present invention is to provide a system and method capable of reduction of false positives during the detection of objects of interest in image data.

Another object of the present invention is to provide an image analysis system and method that utilizes stepwise decision classification to reduce false positives while maintaining true positive detection.

Another object of the present invention is to provide an image analysis system and method that utilizes binary decision diagrams to reduce false positives while maintaining true positive detection.

Another object of the present invention is to provide tuberculosis detection system.

To achieve the at least above objects, in whole or in part, there is provided a an image analysis system, comprising a computer aided detection (CAD) unit for detecting objects of interest, and a stepwise classification unit for managing a number of false positives generated by the CAD unit.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The patent or application file contains at least one drawing executed in color. Copies of this patent or patent application publication with color drawing(s) will be provided by the Patent Office upon request and payment of the necessary fee.

The invention will be described in detail with reference to the following drawings, in which like reference numerals refer to like elements, wherein:

FIG. 1 is a block diagram showing a system for improved detection of objects of interest, in accordance with one embodiment of the present invention;

FIG. 2 is a block diagram of one preferred embodiment of the image analysis system 300 of FIG. 1;

FIG. 3 is a block diagram of one preferred embodiment of the CAD unit 310 of FIG. 2;

FIG. 4 is a table showing examples of false positive objects generated by the CAD unit 310, in accordance with an embodiment of the present invention;

FIG. 5 is a schematic diagram illustrating the spatial morphological features of triangular/round-beaded false positive objects and acid fast bacilli, in accordance with an embodiment of the present invention;

FIG. 6 is a schematic diagram illustrating the luminosity features of round-beaded false positives and acid fast bacilli, in accordance with an embodiment of the present invention;

FIG. 7 is a block diagram showing the stepwise classification approach for the removal of false positives;

FIG. 8 is a flowchart showing one example of such a binary decision diagram, in accordance with an embodiment of the present invention;

FIG. 9 is a graph showing the performance of each binary decision diagram based on false positive classification, in accordance with an embodiment of the present invention; and

FIG. 10 is a graph showing the receiving operating characteristics plots of the overall performance of the image analysis system 300 with the stepwise classification unit 320, in accordance with an embodiment of the present invention.

### DETAILED DESCRIPTION OF PREFERRED EMBODIMENTS

The present invention is particularly applicable to improvement of diagnostic procedures of pathological images containing abnormalities, such as the detection of AFB under a microscope system for the diagnosis of TB. As such, the present invention will be described in connection with the detection of AFB in sputum images for the diagnosis of TB. However, it should be appreciated that the present invention can be used for the computer aided detection of any type of object of interest in images such as, for example, microcalcification clusters, masses and tumors of mammogram images, as well as the detection of explosives or other threat objects in images.

The system and method of the present invention uses an adaptive stepwise classification approach, preferably based on a hierarchical binary decision diagram (BDD), to enable the efficient management of non-AFB false positive (FP) objects to improve detection performance. The present invention can reduce the number of FP or increase the number of FP, pending on the condition of each captured field of view (FOV) image and pending on the condition on each case.

FP objects are preferably classified into several different categories such as, for example, small bright object, beaded FP, dim elongated object, etc. Based on a priori knowledge of AFB, luminosity, contrast, and 3D morphological features are preferably used for the stepwise classification. A binary decision diagram (BDD) is preferably developed to classify different types of FP based on the extracted feature parameters. The decision threshold used in the BDD is preferably determined adaptively, based on the occurrence of FP and true positive (TP) as well as type of FP.

Based on the type and occurrence of FP, each BDD is arranged in a hierarchical classification to manage different types of FP. The present invention is able to significantly reduce the FP on negative cases, whereas the TP in cases that contain high concentration of AFB remains extremely high. The present invention allows for easy extension for the management of any previously unseen FP. As discussed above, the present invention can be used in an automated system and method for processing digital pathological images, and more specifically, to a false positive management system and method for the detection of AFB in sputum smear images using feature extraction, adaptive stepwise classification process and hierarchical binary decision diagrams.

Unlike the methodologies disclosed in related art publications [1]-[7] above, the present invention: (1) preferably utilizes different features involving the morphological shapes of bacilli and brightness due to fluorescence; (2) preferably utilizes stepwise classification that involves multiple classifiers to discriminate between bacilli and different types of non-bacilli objects; (3) preferably determines the threshold values used in the classification based on the frequency of FPs and TPs, as well as types of FPs; and (4) allows for the increase in FPs.

Unlike the related art CAD methodologies, the present invention utilizes a stepwise classification (SWC) that overcomes the classification issues present in the related art by using a priori clinical knowledge. The SWC of the present invention is able to memorize previously learned FP types such that the FPs will not rematerialize when new cases are utilized. The SWC of the present invention enables a significant reduction of non-AFB FP objects while maintaining a similar TP detection to improve performance. The SWC of the present invention performs post-processing to remove the FP generated from the CAD system.

FP objects are first analyzed and classified into several different categories such as, for example, small bright objects, beaded, dim elongated objects, etc. A SWC is developed to remove each type of FP, one at a time. For each individual classification, a binary decision diagram is preferably created through minimization from a Boolean binary decision tree to classify different types of FP based on the extracted feature vectors associated with AFB and non-AFB objects. Each classification algorithm is preferably developed and applied in a sequence to reduce a different type of FP, such that the most dominant category of FP will be removed first. Consequently, the present invention reduces significant amounts of FPs while maintaining consistent true positive detection.

The system and method of the present invention can be automated under processor control, and uses multiple steps of classification processing, adaptive approach, digital image processing, feature extraction, and apriori clinical knowledge to reduce FPs based on the condition of each captured field and case, as well as to increase the number of detected objects to augment the detection accuracy for each AFB. Once image data is acquired (from, for example, a pathological sputum image) or transferred from a network, the image data is subjected to multi-step digital image processing techniques and initial candidate selection techniques to initially identify several suspect candidates. These identified suspect candidates are the processed using the present invention.

Such an automated detection system and method improves the diagnostic procedures of pathological images containing abnormalities, such as acid fast bacilli (AFB). As discussed above, the present invention uses an adaptive stepwise classification approach based on the hierarchical binary decision diagram (BDD) to enable efficient management of non-AFB FP objects in to improve detection performance. FP objects are classified into several different categories such as, by way of example, small bright object, beaded FP, dim elongated object, etc.

A priori knowledge of AFB, size, luminosity, contrast, and 3D morphological features associated with different types of FP are used for the stepwise classification. A binary decision diagram (BDD) is developed and used to classify different types of FP based on the feature parameters. The decision threshold used in the BDD is determined adaptively based on the frequency of FP and TP, as well as types of FP. Based on the type and frequency of FP, each BDD is arranged in a hierarchical classification to manage different FPs.

The present invention increases the sensitivity of TP detection by preferably analyzing only the negative cases, and by recommending further re-assessment only of cases determined to be positive. The present invention is able to significantly reduce the FPs on these negative cases, whereas the TP in the cases that contain high concentrations of AFB remains extremely high. The present invention allows easy extension for the management of any previously unseen FPs.

Some characteristics of the present invention include, but are not necessarily limited to, the following:

(1) Management of FP, rather than just FP reduction;
(a) The present invention can either reduce FP and/or TP or increase FP and/or TP.
(b) Adaptive adjustment to mimic human for high load and scanty at field of view and case level.

(2) Decision threshold is weighted and adjusted based on the frequency of particular types of FPs and performance of previous classifier;

(3) Stepwise FP classification is based on hierarchical binary decision diagram (BDD);
(a) The BDD handles one type of FP at a time
(b) Allows extension for the management of any future unseen FPs
(c) Allows divide-and-conquer to properly manage the performance of each step of classification

(4) Identifies and differentiates between different types of FP rather than grouping all types of FPs into one category;

(5) The features that are identified/extracted are based on apriori knowledge; and
(a) Use of morphological features
   (i) formulated into 3D form (e.g., 2D thickness and 1D luminosity)
(b) Use of brightness features
   (i) high contrast
   (ii) luminosity instead of color

(6) Use adaptive rules for the management of FP and for determination of cut-off threshold.
(a) Adaptive rules used to determine when to apply a different FP reduction algorithm
   (i) High frequency of an FP type→reduce FPs more with more loss of AFBs
   (ii) Low frequency of an FP type→moderate reduction of FPs
(b) Adaptive rules used to recover all lost AFBs
   (i) Based on human vision system
   (ii) High number of candidates→recover all lost AFBs and FPs
   (iii) Low number of candidates→maintain same number of outputs

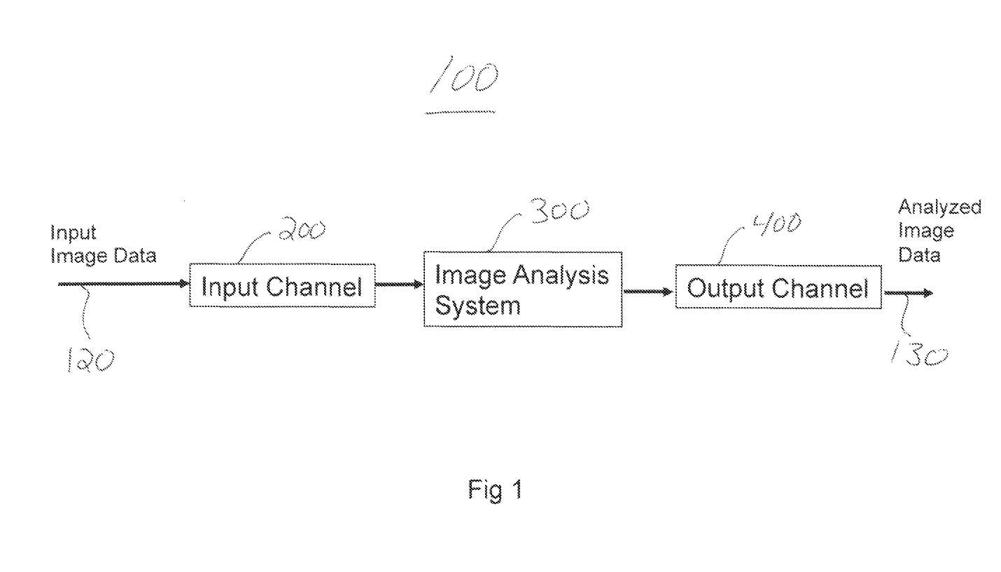

FIG. 1 is a block diagram showing a system 100 for improved detection of objects of interest, in accordance with one embodiment of the present invention. The present invention will be described in the context of detection of AFBs for diagnosis of tuberculosis. However, the present invention can be used for improving the detection of any object of interest.

The system 100 comprises an input channel 200 for inputting image data 120 from an image source (not shown), an image analysis system 300 and an output channel 400 for outputting analyzed image data 130. The image analysis system 300 preferably utilizes adaptive stepwise classification and hierarchical binary decision diagrams for the management of FPs.

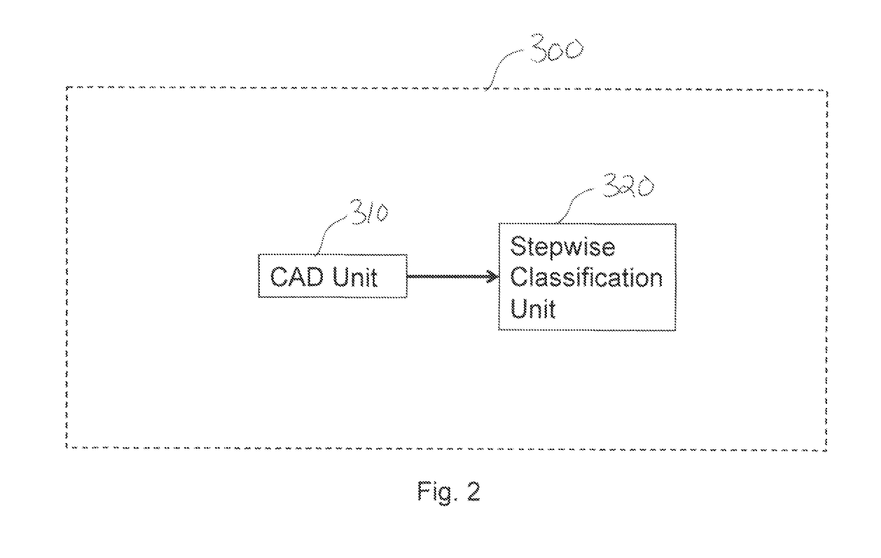

FIG. 2 is a block diagram of one preferred embodiment of the image analysis system 300. The image analysis system 300 includes a CAD unit 310 and a stepwise classification unit 320. The operation of the image analysis system 300 will be explained below in more detail below in connection with tuberculosis detection. However, it should be appreciated that the image analysis system can be adapted for the detection of other objects of interest, such as cancer cells or threat objects (e.g., explosives).

### Reduction of False Positives in Tuberculosis Detection

### A. Database

Two types of specimen databases were used to develop and evaluate the image analysis system 300: (1) a development specimen database; and (2) an independent testing specimen database. For the development database, a total of 554 specimens were collected and digitized by the National TB Reference Laboratory, National Health Laboratory Systems (NHLS), Johannesburg, South Africa in 2008 and 2009. These specimens are sputum smear slides stained with auramine-O.

An Olympus BX41 fluorescence microscope (Olympus, Japan) equipped with 100 W mercury light source and 1.2-mega-pixel Olympus XC10 color digital camera with a Peltier cooling filter were used to capture each field of view (FOV). Five to one hundred FOVs were captured for each specimen through a 40× magnification objective lens. In total, 1,803 AFB-positive FOVs and 6,082 AFB-negative FOVs were collected for the development of the detection algorithms.

The positive FOVs were collected from TB positive specimens. The negative FOVs were collected only from TB negative specimens to prevent any accidental contamination between the positive and negative FOVs. The positivity and severity classification of these FOVs were confirmed by an expert microscopist. Each FOV covers a rectangular area of 166 mm×221 mm at 160 nm pixel resolutions. Over 40,000 individual AFB and approximately 80,000 non-AFB objects were identified and extracted into rectangular areas.

In 2010, additional cases were collected from NHLS for the independent evaluation of a CAD algorithm used by the CAD unit 310 of the image analysis system 300. These cases have not only been confirmed by consensus human observers to determine their positivity and existence of AFB, but also their severity load. The severity load is defined as “high concentration specimen” (grade P1 or higher), “scanty specimen” (grade ‘scanty 1’ through ‘scanty 9’), or “negative specimen” (no AFB exist), in accordance with the International Union Against Tuberculosis and Lung Diseases (IUATLD) grading scale for AFB. A total of 102 cases are identified as negative cases and 74 as positive cases.

Among the positive cases, 25 of them were identified as scanty cases and the remainders were P1, P2, and P3 cases. These independent cases were not used for the development of the CAD algorithm used by the CAD unit 320, nor the stepwise classification algorithm used by the stepwise classification unit 320. Patient and clinical information on these development and testing specimens were not identified or traced.

### B. CAD Unit (310)

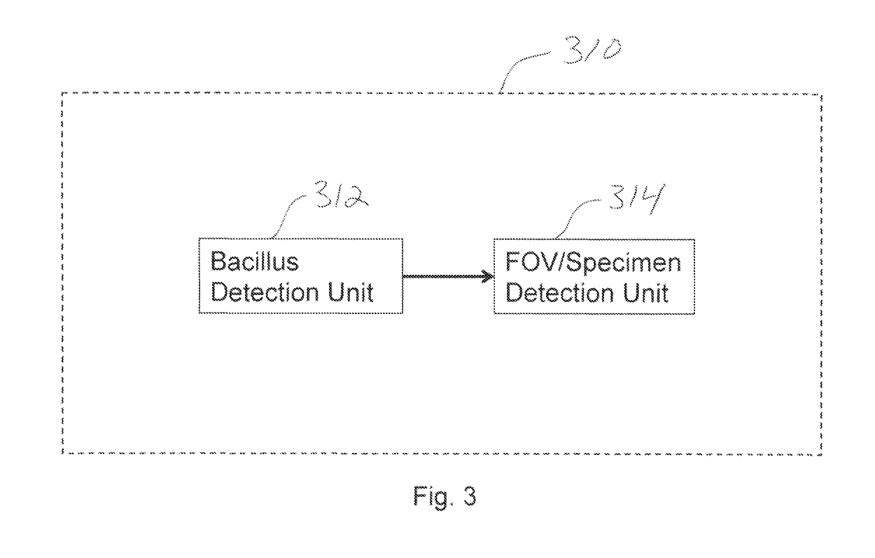

FIG. 3 is a block diagram of one preferred embodiment of the CAD unit 310. The CAD unit 310 preferably includes a bacillus detection unit 312 and a FOV/Specimen detection unit 314. The bacilli detection unit 312 preferably performs the following processes/steps: (1) object segmentation to select the majority of AFB objects along with other non-AFB objects; (2) segregation process to separate AFB from non-AFB categories; (3) feature extraction to calculate the mathematical expression of TP and FP objects in the image; and (4) support vector machine (SVM) processing to automatically determine the likelihood of AFB objects.

The bacillus detection unit 312 preferably displays a graphical indicator superimposed on an image to indicate the likelihood of an object in the image being an AFB. For example, the bacillus detection unit 312 can suitably draw a red bounding box around a suspect object to indicate its likelihood of being an AFB. Based on the results of the bacillus level detection by the bacillus detection unit 312, the FOV/Specimen detection unit 314 totals the results from the bacillus detection unit 312 to determine the overall AFB status of the FOVs and the specimen following the IUATLD grading scale. The CAD unit 310 can achieve a sensitivity higher than 90%, at the cost of high number of FP objects.

### C. Stepwise Classification Unit (320)

The stepwise classification (SWC) unit 320 is used in post-processing to process all objects generated by the CAD unit 310 in order to reduce the number of FPs. During testing, the features used in the SWC unit 320 were not used in the CAD unit 310 to assure independence.

After processing by the CAD unit 310 (referred to herein as “pre-scan”), several FPs are generated along with TPs. The FPs are analyzed and classified into predetermined categories such as, by way of example:
(a) small bright object with shape similar to a “small pinhead”;
(b) large bright object with shape similar to a ‘large pinhead’;
(c) dim elongated object;
(d) triangular object with shape similar to a ‘Christmas tree’ or ‘comet’;
(e) two or three separating round beads (cocci-like shape) with shape similar to a ‘snow man’;
(f) elongated object with large middle portion-spore-like FP; and
(g) other FP objects.
   Each of the predetermined categories is preferably maintained as independent as possible in order to minimize false classification. It should be appreciated that the above categories simply examples of categories that are particularly suited for the reduction of FP objects during TB detection. Other classifications can be used, depending on the objects of interest being detected, while still falling within the scope of the present invention. For example, the categories that would be used for reducing FP objects during the detection of cancer cells would be different than the categories listed above. Similarly, the categories that would be used for reducing FP objects during the detection of threat objects (e.g., explosives) would be different than the categories listed above.

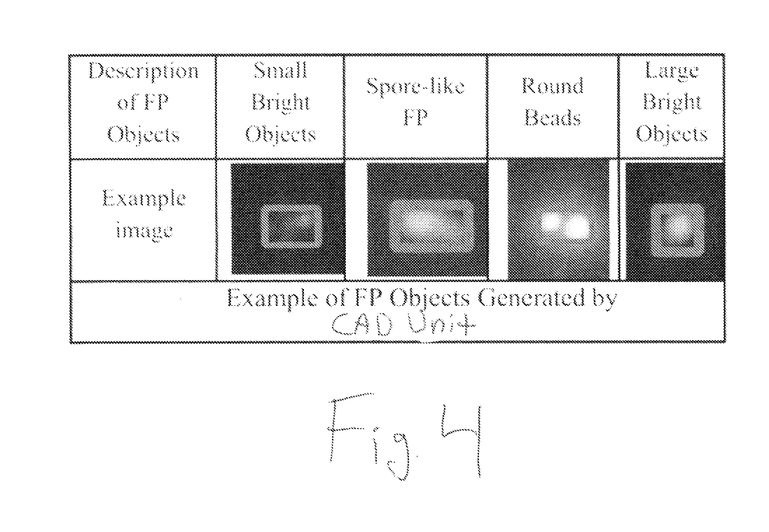

FIG. 4 is a table showing examples of FP objects generated by the CAD unit 310. Based upon the occurrence and dominance of the FP objects, a priority ranking was established to remove the FP objects. The most frequently appearing FP objects were removed first, then the second most frequent, the third most frequent, etc. The dominance of FP objects is ranked as: (1) small bright object, (2) large bright object, (3) dim elongated object, (4) triangular object with shape similar to a ‘Christmas tree’ or ‘comet’, (5) two or three separating round beads (cocci-like shape) with shape similar to a ‘snow man’, (6) elongated object with large middle portion-spore-like FP, and (7) other FP objects. The FP classifier is designed to remove FP objects in the above order.

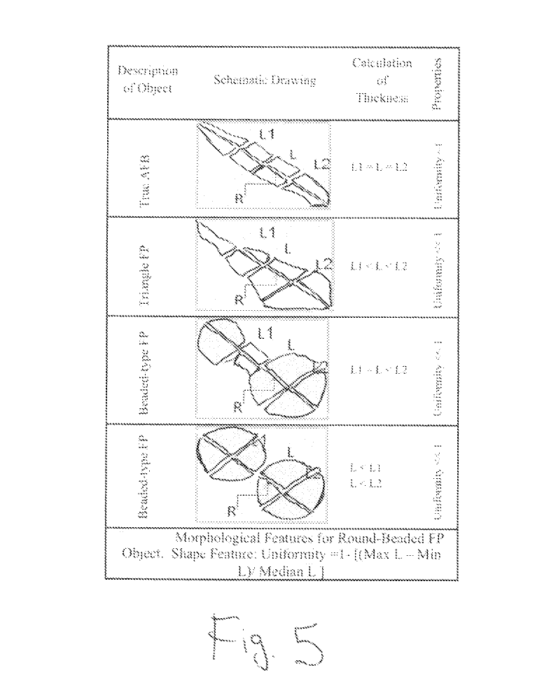

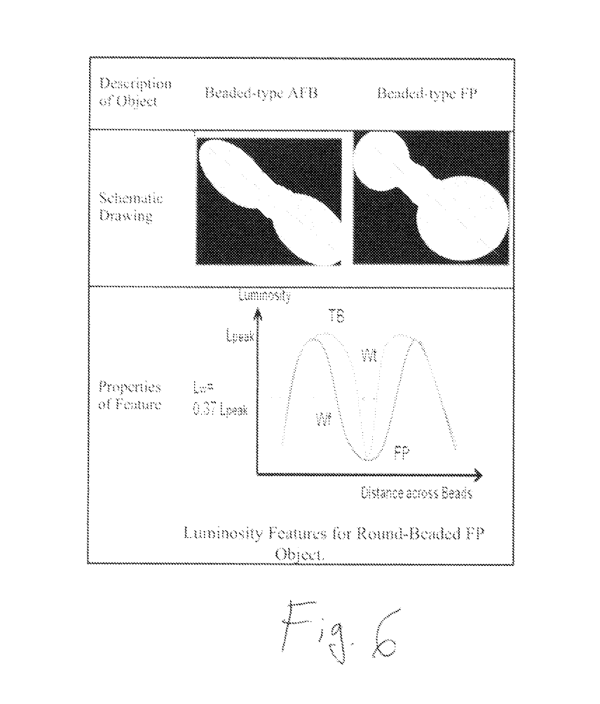

Each classification performs a decision of FP based on the features derived from a priori clinical knowledge:
(a) small bright object: use the size of the bounding box drawn by the CAD unit 310 as criteria; use a diagonal ratio as a feature to consider the rotated objects;
(b) Large bright object: use the size of the bounding box object as criteria; use the diagonal ratio as the feature to consider the rotated objects;
(c) dim elongated object: calculation of the average luminosity in the peripheral region vs. in the central region;
(d) triangular shaped object with shape similar to a ‘Christmas tree’ or ‘comet’—use a thickness ratio at different locations across the object (shown in FIG. 5);
(e) round-beaded object: two or three separated round beads with shape similar to a ‘snow man’ or ‘cocci’
   i. Spatial feature—use a thickness ratio at different locations (shown in FIG. 5).
   ii. Luminosity—use the profile along the long axis to determine the first and second derivatives, as well as the distance between two peaks (shown in FIG. 6).
(f) elongated object with a large middle portion with a shape similar to a ‘UFO’—use a thickness ratio at different locations.
   i. a uniform elongated object with the ratio of the short axis to long axis is relatively larger—use a thickness ratio at different locations (shown in FIG. 5).

Features used to remove small and large FP objects, as well as dim FP objects, can be easily calculated from the bounding box. The features used to remove other types of FP objects (e.g., the rounded bead FP object and triangle FP object) are extracted based on the schematic diagrams shown in FIGS. 5 and 6.

FIG. 5 is a schematic diagram illustrating the spatial morphological features of triangular/round-beaded FP objects and AFB. The long axis, short axis, width along the long axis, as well as the ratio is computed. The morphology of an AFB possesses a rod shape and is slightly bent. The width of the AFB is uniform along the object, whereas the triangular and round-beaded FP objects do not possess width uniformity. For the true AFB, its uniformity is close to “1”, otherwise its uniformity is much less than for the triangle and beaded FP objects.

FIG. 6 is a schematic diagram illustrating the luminosity features of round-beaded FP and AFB. The gray-scale luminosity is derived from values of the Red, Green, and Blue channels. Diagonal profile(s) of luminosity are then generated to differentiate beaded AFB from beaded non-AFB. The separation of peak luminosities in the profile for FP is bigger than that from AFB and the size of each bead for FP is smaller than the AFB. The spatial size of each bead is calculated between two profile distances where its peak luminosity drops to 37% (=e⁻¹), which is about one standard deviation.

Based on the above prioritization of FP objects, a SWC algorithm is constructed using several individual binary decision diagrams (BDD) to remove each category of FP objects, one type of FP object at a time. FIG. 4 is a block diagram that represents a SWC algorithm for the removal of FP objects, in accordance with one preferred embodiment of the present invention. As shown in FIG. 4, each classification is designed to remove the maximum number of FP objects with minimal loss of TB objects.

A stepwise classification (SWC) differs from a simultaneous classifier that differentiates all types of FP categories at one time. A SWC can be derived from the simultaneous classification, provided that each type of FP and the associated feature vectors are independently distributed using cofactors from a Boolean function.

Simultaneous classification can be represented as a Boolean function F of n feature variables vector X₁, X₂, X₃, . . . , Xₙ associated with different types of FPs. Each vector (Xᵢ) can consist of multiple feature elements x_{i,1}, x_{i,2}, . . . , x_{i,n)}.
F: {0,1}ⁿ−>{0,1}
   where 0 can be FP and 1 can be TP.
It indicates that use of X₁, X₂, . . . , Xₙ simultaneously can classify FP from TP.

SWC can be derived from the simultaneous classification provided that each type of FP and associated feature vectors are independently distributed.
Use of cofactor (Fₓ₁ and Fx1 ) to re-define the Boolean function of n−1 variables as follows:
   Fₓ₁(X₁, X₂, . . . , Xₙ)=F(1, X₂, X₃, . . . , Xₙ)
   Fx1 (X₁, X₂, . . . , Xₙ=F(0, X₂, X₃, . . . , Xₙ)
   It indicates that a class of X₁ can be singled out to classify TP and FP while the remaining variables X₂, X₃, . . . , Xₙ can be used simultaneously to classify TP and FP.
By repeating the usage of the cofactor, one can use X₁, X₂, . . . , Xₙ independently to classify TP from FP, one type of FP at a time:
   F: {0,1}ⁿ−>{0,1}ⁿ⁻¹−>{0,1}ⁿ⁻²−> . . . −>{0,1}

As independency between each feature vector or the independency between different categories of FP begin to diminish, the false classification will increase because of the introduction of adjudicate correlation from the dependency of categories of FP.

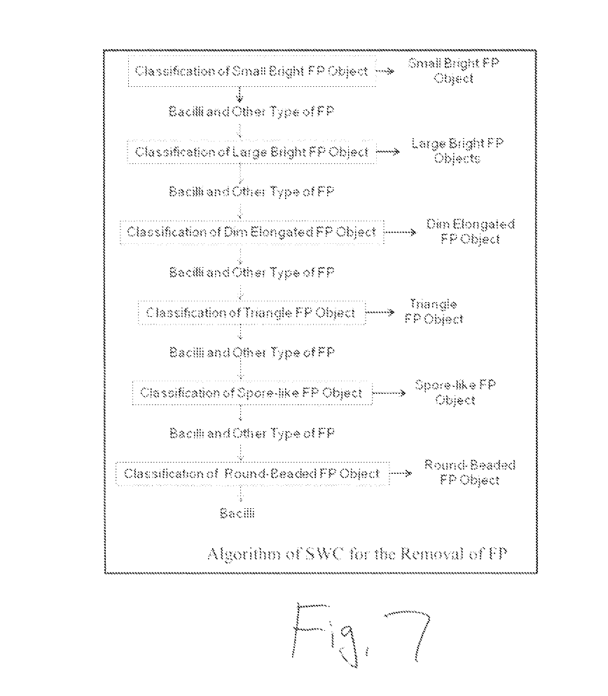

FIG. 7 is a block diagram showing the SWC approach for the removal of FP. It removes small bright FP objects first; then large bright FP objects; and then dim elongated FP objects. The last three types of FP objects to be removed are triangular FP objects, spore-like FP objects, and round-beaded FP objects. SWC algorithms allow easy evaluation of the performance of the classification algorithm. The performance of the classification algorithm designed to remove small bright FP objects can be evaluated by examining not only the change of sensitivity and FP rate but also by examining the remaining objects to determine how many small, bright FP objects have been removed. Ideally, all of the small, bright FP objects should have been removed after the first classification algorithm.

The SWC allows the use of specific feature vectors for specific types of FP. It does not require extensive training since the decision threshold is determined from the apriori clinical knowledge instead of from the training of the samples. The SWC processes feature vectors instead of an individual feature element, for one type of FP. This also can avoid the potential of introducing any non-relevant feature elements typically encountered in the simultaneous classification.

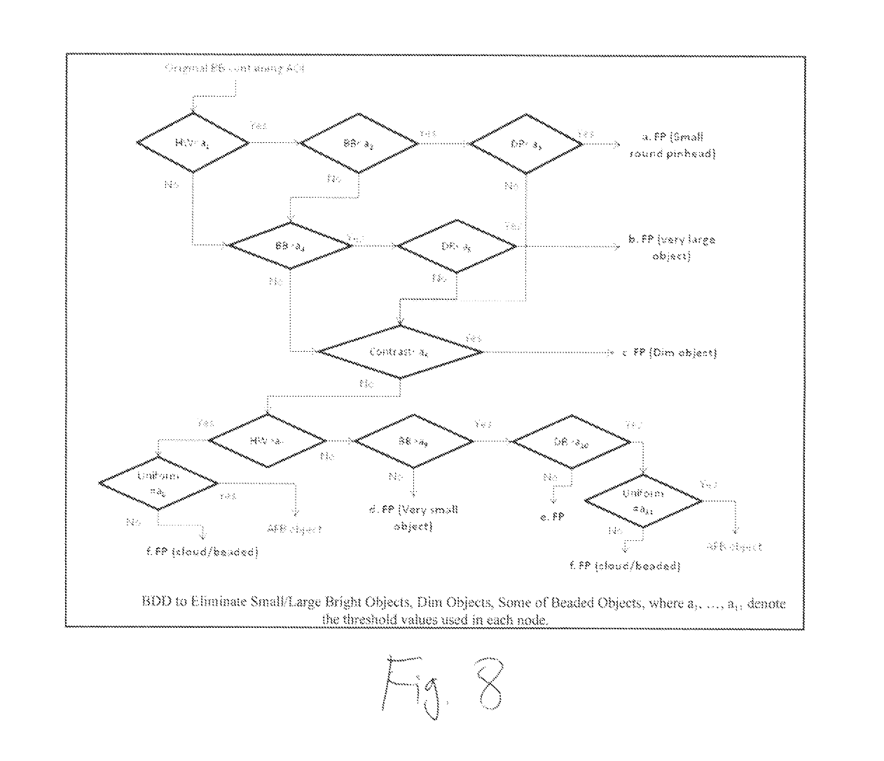

The stepwise classification unit 320 utilizes a binary decision diagram (BDD) for each FP classification algorithm to remove each category of FP. FIG. 8 is a flowchart showing one example of such a BDD. The BDD, or sometimes called Reduced Ordered Binary Decision Diagram (ROBDD), is typically obtained from the binary decision tree by maximally reducing it according to the reduction rules: (1) merge any isomorphic sub-graphs; and (2) eliminate any node whose two children are isomorphic. A binary decision tree is a Boolean function and sometimes referred to as a Boolean decision tree, where each node can only generate two outputs, such as TP and FP for the last child node. The feature elements are implemented at each node. BDD has been demonstrated to produce a much lower cross-validation misclassification rate. Karnaugh Map is a typical and suitable way to generate a BDD from a Boolean binary decision tree.

The advantage of a BDD is that it is canonical, unique, and efficient for a particular function and variable order. This property makes it useful in the functional equivalence checking of each feature element from the feature vectors associated with each FP, in addition to other operations, such as functional technology mapping in switching circuit and real-time computer vision.

One BDD has one root node and several child nodes. Each node represents a Boolean function that determines the threshold values for specific features. Each node only has two outputs and each output can be the input to another node. As the path descends from root node to a low child (high child), that node's variable is assigned to 0 and a decision is then made to be either FP or AFB. The size of the BDD is determined both by the function being represented and the chosen ordering of the variables. Multiple BDDs can be combined and minimized to generate a single global BDD.

The first FP classification is designed to eliminate the small bright FP object with a cut-off threshold near the bottom, such that most of the FP will be removed. This FP classification consists of two BDDs: (1) one to remove the smaller bright object aligned on the vertical and horizontal position; and (2) a second BDD that checks rotation using diagonal ratio and then applies the checking of the size of detected objects.

FIG. 8 shows the portion of the BDD that eliminates small bright objects, large bright objects, dim objects, and some of the beaded objects. Each node performs a Boolean function to arrive at a binary decision. The computation on each node is very simple, involving the size of the bounding box (“BB”), diagonal ratio (“DR”), contrast, uniformity, etc. The cut-off thresholds are obtained based on the clinical knowledge of AFB. The outputs from this algorithm include AFB objects and some of the FPs that were not removed by this BDD.

The BDD of FIG. 8 can be utilized for the removal of triangle and round-beaded FP objects and is derived from a binary decision tree based on the features described in FIGS. 6 and 7. The decision tree classifier includes 7 Boolean functions: (1) comparison of the top three thicknesses; (2) comparison of max and min thickness; (3) comparison of the thickness with the middle axis; (4) comparison of the luminosity difference between mountain and valley of the profile along the long axis; (5) comparison of the second derivatives of the luminosity profile; (6) comparison of the size of each bead based on the width of the luminosity profile; and (7) comparison of the distance between two peaks on the luminosity profile. The cut-off thresholds for each BDD were chosen to remove the FP slightly (low FP rate) while preserving the most TP (high sensitivity). The classification implemented in the BDD also can be realized in parallel processing via a simple logical gate operation.

The performance of classification is first evaluated on each individual FP classification algorithm. An overall performance is then reported using Receiving Operating Characteristics (ROC) analysis. Both performances were obtained from cases that were not used for the development of the algorithms for the CAD unit 310 and the SWC unit 320.

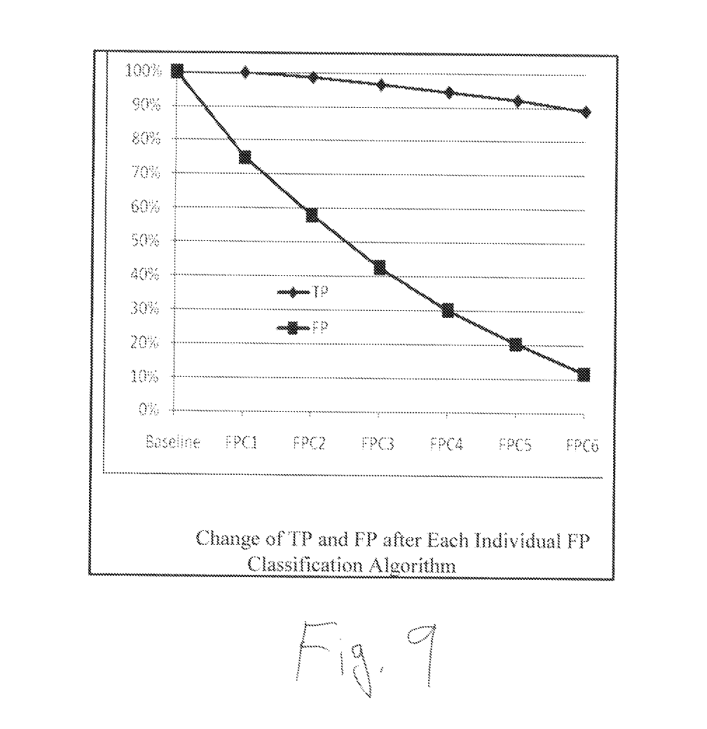

FIG. 9 is a graph showing the performance of each BDD based on FP classification. The total number of TP and FP generated from the CAD TB detection system are used as the baseline. The remaining TP and FP from each FP classification algorithm are then compared with the baseline. The graph of FIG. 9 shows that after 6 SWC's, denoted as FPC1, FPC2, . . . , FPC6, the FP is reduced significantly to 11.69% (changes from 4,773 to 558) while the loss of TP is very minimal, 10.79% (changes from 121 to 108). Investigation of the remaining FP objects after each FP classifier shows that significant amounts of a certain type of FP have been successfully removed consistently.

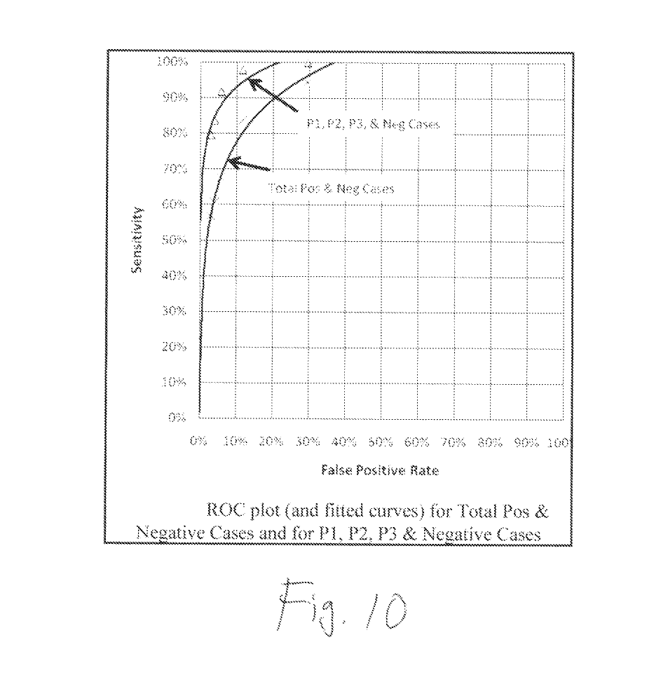

FIG. 10 is a graph showing the receiving operating characteristics (ROC) plots of the overall performance of the image analysis system 300 with the SWC unit 320. The sensitivity is calculated only from the positive cases whereas the specificity is calculated only from the negative cases. The ROC plot includes the sensitivity from a total 74 positive cases (i.e., combination of 25 scanty and 49 P1,P2,P3 or “high-concentration” cases only). The 102 confirmed negative and 74 positive cases were neither utilized during training nor used for the development of the CAD unit 310. The area under the curve shows the superior detection performance on the high-concentration cases (A_{z}=0.913) and cases mixed with high-concentration and scanty AFB cases (A_{z}=0.878).

The image analysis system 300, including the CAD unit 310 and the stepwise classification unit 320 can be implemented with a general purpose computer. However, they can also be implemented with a special purpose computer, programmed microprocessor or microcontroller and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of executing code for implementing the algorithms, process steps and functions discussed above can be used to implement the image analysis system 300.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the present invention, as defined in the following claims.

What is claimed is:

1. An image analysis system, comprising:
a computer aided detection (CAD) unit for detecting objects of interest; and
a stepwise classification unit for managing a number of false positives generated by the CAD unit.

2. The system of claim 1, wherein the objects of interest comprise acid fast bacilli.
